(19) United States
(12) Patent Application Publication
(10) Pub. No.: US 2020/0313506 A1
(43) Pub. Date: Oct. 1, 2020

(54) MOTOR AND DRIVE APPARATUS

(71) Applicant: NIDEC CORPORATION, Kyoto (JP)

(72) Inventors: Jun MURAKAMI, Kyoto (JP); Kazuyuki YAMAMOTO, Kyoto (JP); Daisuke OGASAWARA, Kyoto (JP); Yuki ISHIKAWA, Kyoto (JP)

(21) Appl. No.: 16/788,309

(22) Filed: Feb. 12, 2020

(30) Foreign Application Priority Data
Mar. 29, 2019 (JP) 2019-067644

(51) Int. Cl. H02K 5/24; H02K 1/18; H02K 7/00; B60K 1/00

(52) U.S. Cl. CPC H02K 5/24; B60K 1/00; H02K 7/006; H02K 1/185

(57) ABSTRACT

A motor according to a preferred embodiment of the present disclosure includes a rotor arranged to be capable of rotating about a central axis, a stator located radially outside of the rotor, a housing arranged to house the rotor and the stator, and a plurality of bolts arranged to fasten the stator to the housing. The housing includes a tubular portion arranged radially outside of the stator to surround the stator; a plurality of stator support portions each of which is arranged to project radially inward from an inner circumferential surface of the tubular portion, and includes a seating surface arranged to face a first axial side; and screw holes each of which is arranged to open in the seating surface of a separate one of the stator support portions. The stator includes a plurality of through holes each of which is arranged to extend along an axial direction. The bolts are passed through the through holes of the stator and screwed into the screw holes of the stator support portions. The housing includes a rib arranged to project radially outward from an outer circumferential surface of the tubular portion on the first axial side of the seating surfaces of the stator support portions.

### CROSS-REFERENCE TO RELATED APPLICATIONS

The present invention claims priority under 35 U.S.C. § 119 to Japanese Application No. 2019-067644 filed on Mar. 29, 2019 the entire content of which is incorporated herein by reference.

### FIELD OF THE INVENTION

The present disclosure relates to a motor and a drive apparatus.

### BACKGROUND

In a known electric motor installed for a transaxle of a vehicle, a stator of the electric motor is fixed to a case using three bolts. In this known electric motor, one of the bolts used to fasten the stator to the case is fixed to the case at both ends thereof to prevent a vibration of the stator from causing noise of the case.

However, in the case of the above-described known structure, an effect of reducing noise may be decreased if the number of bolts or the position of any bolt is changed.

### SUMMARY

A motor according to a preferred embodiment of the present disclosure includes a rotor arranged to be capable of rotating about a central axis, a stator located radially outside of the rotor, a housing arranged to house the rotor and the stator, and a plurality of bolts arranged to fasten the stator to the housing. The housing includes a tubular portion arranged radially outside of the stator to surround the stator; a plurality of stator support portions each of which is arranged to project radially inward from an inner circumferential surface of the tubular portion, and includes a seating surface arranged to face a first axial side; and screw holes each of which is arranged to open in the seating surface of a separate one of the stator support portions. The stator includes a plurality of through holes each of which is arranged to extend along an axial direction. The bolts are passed through the through holes of the stator and screwed into the screw holes of the stator support portions. The housing includes a rib arranged to project radially outward from an outer circumferential surface of the tubular portion on the first axial side of the seating surfaces of the stator support portions.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a motor unit according to a preferred embodiment of the present disclosure as viewed from above.

FIG. 2 is a perspective view of the motor unit according to a preferred embodiment of the present disclosure as viewed from below.

FIG. 3 is a side view of the motor unit according to a preferred embodiment of the present disclosure.

FIG. 4 is a vertical sectional view of a portion of the motor unit according to a preferred embodiment of the present disclosure, illustrating a motor and its vicinity.

FIG. 5 is a horizontal sectional view of a portion of the motor unit according to a preferred embodiment of the present disclosure, illustrating the motor and its vicinity.

FIG. 6 is a perspective view illustrating a vibration reduction structure according to a modification of the above preferred embodiment of the present disclosure.

### DETAILED DESCRIPTION

Hereinafter, the structures of motor units according to preferred embodiments of the present disclosure will be described with reference to the accompanying drawings.

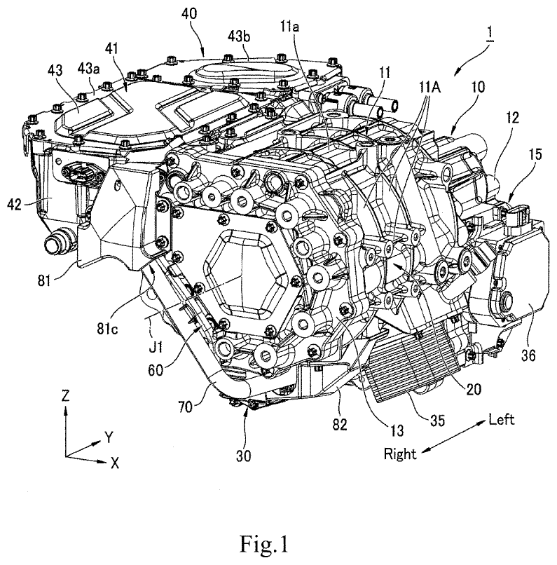

The following description will be made with a vertical direction being defined on the basis of positional relationships when a motor unit 1 according to a preferred embodiment of the present disclosure illustrated in FIG. 1 is installed in a vehicle located on a horizontal road surface. In addition, in the drawings, an xyz coordinate system is shown appropriately as a three-dimensional orthogonal coordinate system. In the xyz coordinate system, a z-axis direction corresponds to the vertical direction with a +z side and a −z side corresponding to an upper side and a lower side, respectively. An x-axis direction corresponds to a front-rear direction of the vehicle in which the motor unit 1 is installed, and is a direction perpendicular to the z-axis direction. In the present preferred embodiment, a +x side corresponds to a forward side of the vehicle, while a −x side corresponds to a rearward side of the vehicle. A y-axis direction corresponds to a left-right direction of the vehicle, and is a direction perpendicular to both the x-axis direction and the z-axis direction. In the present preferred embodiment, a +y side corresponds to a left side of the vehicle, while a −y side corresponds to a right side of the vehicle. In the present preferred embodiment, the right side corresponds to a first axial side, i.e., one side in an axial direction, while the left side corresponds to a second axial side, i.e., another side in the axial direction. In the present preferred embodiment, the front-rear direction corresponds to a predetermined direction.

Note that the definition of the forward and rearward sides in the front-rear direction is not limited to the definition of the present preferred embodiment, and that the +x side and the −x side may correspond to the rearward side and the forward side, respectively, of the vehicle. In this case, the +y side corresponds to the right side of the vehicle, while the −y side corresponds to the left side of the vehicle.

A motor axis J1 shown appropriately in the drawings extends in the y-axis direction, i.e., the left-right direction of the vehicle. In the following description, unless otherwise specified, a direction parallel to the motor axis J1 will be simply referred to by the term “axial direction”, “axial”, or “axially”, radial directions centered on the motor axis J1 will be simply referred to by the term “radial direction”, “radial”, or “radially”, and a circumferential direction centered on the motor axis J1, i.e., a circumferential direction about the motor axis J1, will be simply referred to by the term “circumferential direction”, “circumferential”, or “circumferentially”. It is assumed that the term “parallel” as used herein includes both “parallel” and “substantially parallel”, and that the term “perpendicular” as used herein includes both “perpendicular” and “substantially perpendicular”.

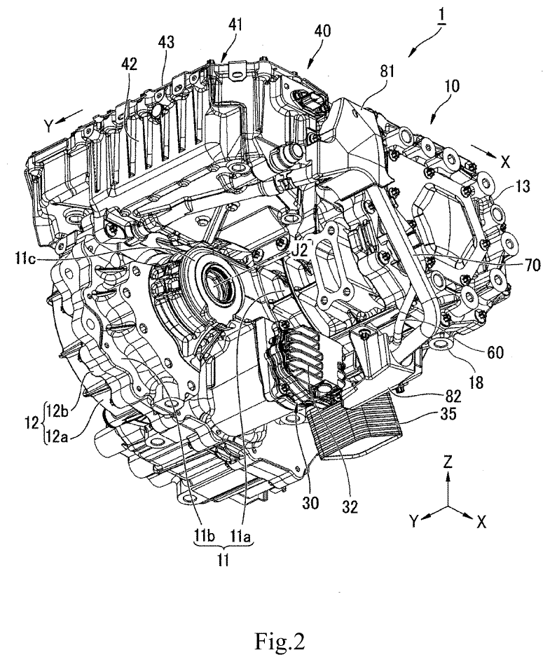

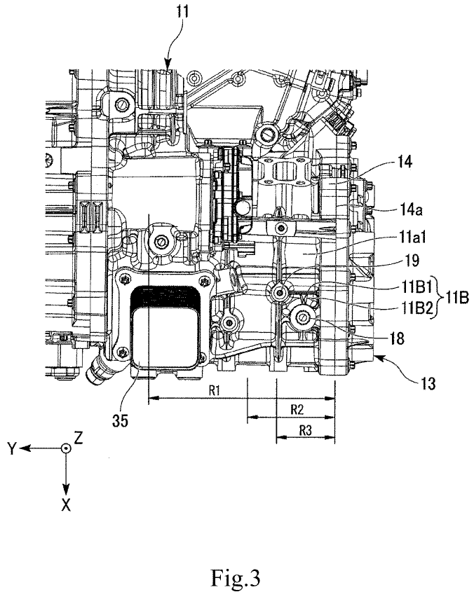

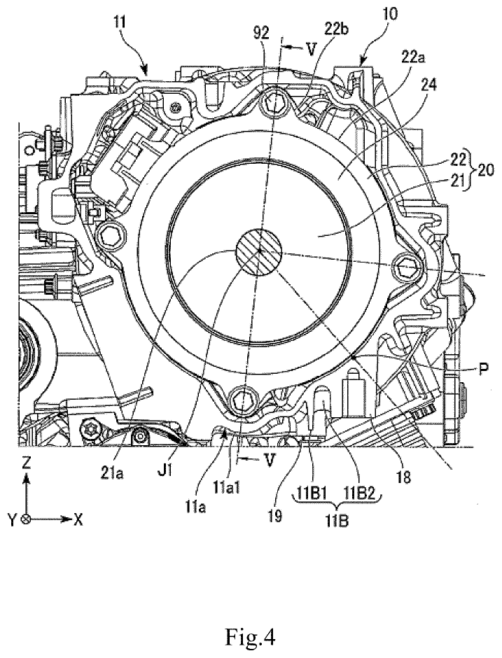

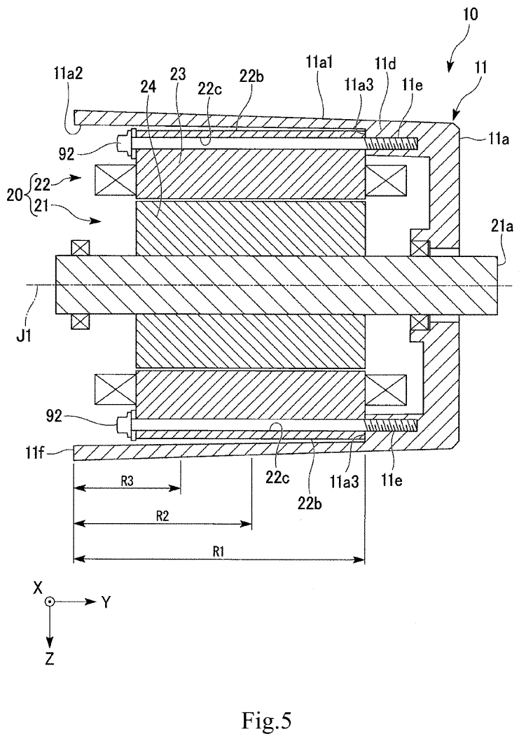

FIG. 1 is a perspective view of the motor unit according to a preferred embodiment of the present disclosure as viewed from above. FIG. 2 is a perspective view of the motor unit according to a preferred embodiment of the present disclosure as viewed from below. FIG. 3 is a side view of the motor unit according to a preferred embodiment of the present disclosure. FIG. 4 is a vertical sectional view of a portion of the motor unit according to a preferred embodiment of the present disclosure, illustrating a motor and its vicinity. FIG. 5 is a horizontal sectional view of a portion of the motor unit according to a preferred embodiment of the present disclosure, illustrating the motor and its vicinity.

The motor unit (i.e., a drive apparatus) 1 is installed in a vehicle having a motor as a power source, such as, for example, a hybrid electric vehicle (HEV), a plug-in hybrid vehicle (PHV), or an electric vehicle (EV), and is used as the power source thereof. Referring to FIGS. 1 to 4, the motor unit 1 includes a housing 10, a motor 20, and an inverter unit 40. The motor unit 1 further includes a reduction gear and a differential, which are not shown in the drawings.

The housing 10 is arranged to house the motor 20, the reduction gear (not shown), and the differential (not shown). An oil, which is not shown in the drawings, is housed in an interior of the housing 10. Referring to FIGS. 1 to 3, the housing 10 includes a housing body 11, a gear cover 12, and a motor cover 13.

Referring to FIG. 2, the housing body 11 includes a motor housing 11a and a joining portion 11b. The motor housing 11a is tubular, and is arranged to extend in an axial direction, surrounding the motor axis J1. The motor housing 11a is arranged to open to the right side, which corresponds to the −y side in the drawings. The motor housing 11a is arranged to house the motor 20. The joining portion 11b is arranged at an end portion of the motor housing 11a on the left side. The joining portion 11b is arranged to project to the rearward side relative to the motor housing 11a.

Referring to FIGS. 4 and 5, the housing body 11 according to the present preferred embodiment includes the tubular motor housing (i.e., a tubular portion) 11a, which is arranged radially outside of a stator 22 to surround the stator 22, a plurality of stator support portions lid each of which is arranged to project radially inward from an inner circumferential surface 11a2 of the motor housing 11a and includes a seating surface 11a3 arranged to face the first axial side, and screw holes 11e each of which is arranged to open in the seating surface 11a3 of a separate one of the stator support portions 11d.

Referring to FIG. 4, the motor 20 includes a rotor 21 and the stator 22. The rotor 21 of the motor 20 is arranged to rotate about the motor axis J1. The rotor 21 of the motor 20 is connected to the reduction gear (not shown), which is housed in the gear cover 12.

Referring to FIGS. 4 and 5, the stator 22 is located radially outside of the rotor 21. The stator 22 includes a stator core 23 and a plurality of coils 24. The stator 22 is annular, surrounding the rotor 21, and is fixed to an inside of the motor housing 11a.

Referring to FIG. 4, the stator 22 according to the present preferred embodiment includes a plurality of bolt fastening portions 22b each of which is arranged to project radially outward from an outer circumferential surface 22a of the stator 22. The bolt fastening portions 22b are arranged at regular intervals in the circumferential direction on the outer circumferential surface of the stator 22. Each bolt fastening portion 22b includes a through hole 22c arranged to pass through the bolt fastening portion 22b in the axial direction.

The stator 22 according to the present preferred embodiment is fastened to the motor housing 11a through a plurality of bolts 92 inserted into the through holes 22c of the bolt fastening portions 22b. In the present preferred embodiment, the number of bolts 92 used is four, and each bolt 92 is passed through the through hole 22c of a separate one of the bolt fastening portions 22b of the stator 22, and is screwed into the screw hole 11e of the corresponding stator support portion 11d, so that the stator 22 is fixed to the motor housing 11a. Note that the number of bolts 92 used to fix the stator 22 to the motor housing 11a is not limited to four.

Referring to FIGS. 1 and 3, the housing body 11 includes a plurality of ribs 11A and 11B arranged on an outer surface of the tubular motor housing 11a. The ribs 11A and 11B include ribs arranged to extend in the axial direction, and ribs arranged to extend in the circumferential direction at a radial end portion of the motor housing 11a. The ribs 11A and 11B improve the rigidity of the housing body 11, and contribute to reducing noise caused by vibrations of the housing body 11 while the motor 20 is operating.

Referring to FIG. 5, in the motor unit 1 according to the present preferred embodiment, the stator 22 is supported only at one end in an interior of the motor housing 11a.

In the case of such a one-sided supporting structure, vibrations of the stator core 23 caused by an electromagnetic force while the motor 20 is operating are transferred to the motor housing 11a through the bolt fastening portions 22b of the stator core 23 and the seating surfaces 11a3. If the motor 20 vibrates in a radial direction of the motor housing 11a, the amplitude of the vibration is large at positions away from the seating surfaces 11a3, which support the stator 22, in the axial direction. The stator core 23 has a natural vibration mode that allows the stator core 23 to vibrate in an elliptical or triangular manner with antinodes and nodes appearing along the annular shape thereof, and therefore, at a resonance frequency of such natural vibration, amplified vibrations may be transferred to cause a significant deformation and vibration of the motor housing 11a and noise. The motor housing 11a tends to vibrate particularly easily in the vicinity of the motor cover 13, which is away from the seating surfaces 11a3 supporting the stator core 23 in the axial direction, and such a vibration as causes bosses 18 and 19 arranged on the lower side of the motor housing 11a to approach and move away from each other may occur.

Accordingly, in the motor unit 1 according to the present preferred embodiment, the ribs 11B as illustrated in FIGS. 3 and 4 are arranged on a portion of the motor housing 11a near an opening 11f of the motor housing 11a on the first axial side in FIG. 5, where the amplitude of the vibration becomes large, i.e., in the vicinity of the motor cover 13. Each of the ribs 11B is a plate-shaped rib arranged to project radially outward from an outer circumferential surface 11a1 of the motor housing 11a.

Referring to FIGS. 3 and 4, the ribs 11B include a first rib 11B1 arranged to extend along the axial direction of the motor axis J1, and a second rib 11B2 arranged to extend in a direction perpendicular to the first rib 11B1, both of which are arranged on a side surface of the motor housing 11a which faces the lower side.

The first rib 11B1 is in the shape of a plate, extending along the axial direction. An end portion of the first rib 11B1 on the left side (i.e., the +y side) in the axial direction is connected to an outer circumferential surface of the boss 19. An end portion of the first rib 11B1 on the right side (i.e., the −y side) is connected to a flange 14 of the housing 10 at an end of the motor housing 11a near the motor cover 13. That is, the first rib 11B1 is arranged to join the boss 19 and the flange 14 to each other. Thus, the first rib 11B1 is arranged to be substantially parallel to the direction of a vibration that compresses or extends the side surface of the motor housing 11a in the direction along the motor axis J1. Because the first rib 11B1 is arranged in such an orientation as to prevent the first rib 11B1 from being easily deformed by the above vibration, the first rib 11B1 contributes to reducing the vibration of the motor housing 11a.

One end portion of the second rib 11B2 is connected to an axial middle of the first rib 11B1. Another end portion of the second rib 11B2 is connected to the boss 18. That is, the second rib 11B2 is arranged to join the first rib 11B1 and the boss 18 to each other in the circumferential direction about the motor axis J1. Thus, radial vibration is reduced by the second rib 11B2, and accordingly, an additional reduction in noise caused by the vibration of the motor housing 11a can be achieved.

In the present preferred embodiment, the ribs 11B are preferably arranged within a specific range in the axial direction on the side surface of the motor housing 11a. Specifically, the ribs 11B are arranged closer to the opening 11f of the motor housing 11a, which is covered by the motor cover 13, than to an opposite end of the motor housing 11a in the direction parallel to the motor axis J1 of the motor 20.

The ribs 11B according to the present preferred embodiment are located within an axial range on the outer circumferential surface 11a1 of the motor housing 11a, the axial range extending from the end of the motor housing 11a on the first axial side toward the seating surfaces 11a3 and having an axial extent equal to one third of an axial distance between the end of the motor housing 11a on the first axial side and each seating surface 11a3. In other words, referring to FIG. 3, the ribs 11B according to the present preferred embodiment are located in an area within an axial range R3 extending from a flange surface 14a of the flange 14 toward the seating surfaces 11a3 of the motor housing 11a and having an axial extent equal to one third of that of an axial range R1 extending from the seating surfaces 11a3 to the flange surface 14a.

The amplitude of the vibration of the motor housing 11a is greatest at the end of the motor housing 11a on the side away from the seating surfaces 11a3, and therefore, as the ribs 11B are located closer to the aforementioned end of the motor housing 11a, a vibration reduction effect can be more remarkably achieved.

In the present preferred embodiment, the ribs 11B are arranged within the axial range R3, where the above effect can be most remarkably achieved, but the vibration reduction effect can be achieved if the ribs 11B are located on the side of the seating surfaces 11a3 closer to the opening 11f of the motor housing 11a. In addition, preferred positions of the ribs 11B are in an area within an axial range R2 extending from the flange surface 14a toward the seating surfaces 11a3 and having an axial extent equal to half of that of the axial range R1. That is, a large vibration reduction effect, if not as large as can be achieved in the present preferred embodiment, can be achieved if the ribs 11B are arranged within the axial range extending from the aforementioned end of the motor housing 11a toward the seating surfaces 11a3 and having an axial extent equal to half of that of the axial range R1.

Referring to FIG. 4, the ribs 11B are located between circumferentially adjacent ones of the four bolts 92, which are arranged to fasten the stator 22 to the motor housing 11a, when viewed in the direction parallel to the motor axis J1 of the motor 20.

The stator support portions 11d of the housing body 11, to which the bolts 92 are fastened, do not easily vibrate because the fastening of the bolts 92 increases radial rigidity thereof, but portions of the motor housing 11a which are located between adjacent ones of the stator support portions 11d in the circumferential direction about the motor axis J1 are relatively low in radial rigidity, and therefore tend to easily vibrate in radial directions. Accordingly, a greater vibration reduction effect can be achieved for the whole motor housing 11a when the ribs 11B are arranged on a portion of the outer circumferential surface 11a1 which lies between adjacent ones of the bolts 92 in the circumferential direction about the motor axis J1, and which tends to easily vibrate.

Referring to FIG. 4, in the present preferred embodiment, the ribs 11B are preferably located closer to a circumferential midpoint P between circumferentially adjacent ones of the bolts 92 than to either of the circumferentially adjacent bolts 92 in the circumferential direction. The circumferential midpoint P, which is at the greatest distance from each of the bolts 92 in the circumferential direction, tends to be low in rigidity, and tends to easily vibrate. Arranging the ribs 11B in the vicinity of the circumferential midpoint P contributes to more effectively reducing the likelihood that the motor housing 11a will be deformed, and the likelihood that noise will occur.

The gear cover 12 is fixed to a left side of the housing body 11. In more detail, an end portion of the gear cover 12 on the right side is fixed to the joining portion 11b through screws. Although not illustrated in the drawings, the gear cover 12 is arranged to open to the right side. The gear cover 12 includes a first housing portion 12a and a second housing portion 12b. The first housing portion 12a is located on the left side of the motor housing 11a. The first housing portion 12a is arranged to house the reduction gear (not shown). The second housing portion 12b is joined to a rearward side of the first housing portion 12a. The second housing portion 12b is located on the left side of a portion of the joining portion 11b which projects to the rearward side relative to the motor housing 11a. The second housing portion 12b is arranged to house the differential (not shown). The first housing portion 12a is arranged to project to the left side relative to the second housing portion 12b. That is, the motor unit 1 includes the reduction gear and the differential, which together define a transmission system for transferring power of the motor 20 to axles. The gear cover 12 defines a gear housing 15 arranged to house the reduction gear and the differential of the transmission system together with the joining portion 11b of the housing body 11.

The motor cover 13 is fixed to a right side of the housing body 11. In more detail, the motor cover 13 is fixed to an end portion of the motor housing 11a on the right side through screws. Referring to FIG. 1, the motor cover 13 is arranged to close the opening of the motor housing 11a on the right side.

Rotation of the motor 20 is transferred to the differential (not shown) through the reduction gear (not shown) with the speed thereof being reduced by the reduction gear. The differential is arranged to transfer a torque outputted from the motor 20 to axles of the vehicle. The differential includes a ring gear arranged to rotate about a differential axis J2 parallel to the motor axis J1. The torque outputted from the motor 20 is transferred to the ring gear through the reduction gear.

Referring to FIG. 2, the housing 10 includes an axle connection portion 11c in the joining portion 11b. The axle connection portion 11c is tubular, and is arranged to project to the right side (i.e., the −y side) from a surface of the joining portion 11b which faces the right side. The axle connection portion 11c includes a circular opening portion centered on the differential axis J2. One of the axles of the vehicle is inserted in the opening portion of the axle connection portion 11c, and is connected to the ring gear of the differential. The axles of the vehicle are arranged to rotate about the differential axis J2.

Referring to FIGS. 1 and 2, the motor unit 1 includes an oil pump 30, an oil cooler 35, and an electric actuator 36 as auxiliaries. The oil pump 30 and the oil cooler 35 are arranged at a lower portion of the housing 10. The oil cooler 35 is located at a lower portion of a front end of the motor unit 1. The oil pump 30 is located on the rearward side of the oil cooler 35. The electric actuator 36 is arranged at a forward portion of the housing 10. The electric actuator 36 is a drive device for a parking lock mechanism.

The oil pump 30 is arranged along the motor axis J1. The oil pump 30 includes a heat sink 32 arranged at an end portion thereof on the right side. The heat sink 32 is arranged on a cover member of the oil pump 30. The heat sink 32 is arranged to cool a circuit board contained in the oil pump 30.

Referring to FIGS. 1 and 2, the inverter unit 40 is located on the rearward side of the housing 10. The inverter unit 40 includes an inverter case 41. An inverter (not shown) is housed in the inverter case 41. The inverter in the inverter case 41 is electrically connected to the stator of the motor 20 to drive the motor 20.

The inverter case 41 is fixed to the housing 10. In the present preferred embodiment, the inverter case 41 is fixed to a radially outer surface of the housing 10. In more detail, the inverter case 41 is fixed to a rearward portion of a radially outer surface of the motor housing 11a. That is, the inverter case 41 is fixed to the housing 10 on the rearward side thereof in the front-rear direction, which is perpendicular to the axial direction.

Referring to FIG. 1, the inverter case 41 is substantially in the shape of a rectangular box, extending in the axial direction. The inverter case 41 includes an inverter case body portion 42 and an inverter cover 43. The inverter case body portion 42 is substantially in the shape of a rectangular box, being elongated in the axial direction, and is arranged to open upward.

The inverter cover 43 is arranged to close an upper opening of the inverter case body portion 42. The inverter cover 43 includes a first cover 43a and a second cover 43b. The first cover 43a and the second cover 43b are defined by separate members. The inverter (not shown) is housed in a portion of the inverter case 41 to which the first cover 43a is fitted. Busbars (not shown), which are connected to the inverter, are housed in a portion of the inverter case 41 to which the second cover 43b is fitted.

Referring to FIGS. 1 and 2, a wire harness 60 and a coolant hose 70 are led along a side surface of the motor unit 1 on the right side, i.e., the −y side. Specifically, each of the wire harness 60 and the coolant hose 70 is arranged to extend from a side surface of the inverter case 41 on the right side downward along an end portion of the motor cover 13 on the lower side, and is led to a space on the lower side of the housing 10.

Referring to FIGS. 1 and 2, the motor unit 1 includes a side connector cover 81 arranged at end portions of the wire harness 60 and the coolant hose 70 on the side on which the inverter case 41 lies. In addition, the motor unit 1 includes a lower connector cover 82 arranged at end portions of the wire harness 60 and the coolant hose 70 which lie on the lower side of the housing body 11. That is, in the motor unit 1, each of the wire harness 60 and the coolant hose 70 is arranged to extend between the side connector cover 81 and the lower connector cover 82.

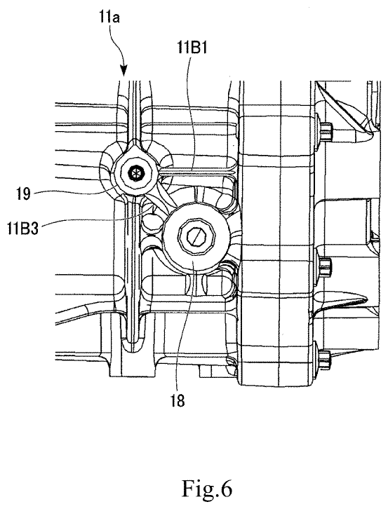

FIG. 6 illustrates a vibration reduction structure according to a modification of the above-described preferred embodiment of the present disclosure.

Referring to FIG. 6, the vibration reduction structure according to this modification includes a first rib 11B1 arranged to join a flange 14 and a boss 19 to each other, and a second rib 11B3 arranged to join a boss 18 and the boss 19 to each other. In this modification, a reduction in such a vibration as causes the bosses 18 and 19 to approach and move away from each other can be achieved by the second rib 11B3 connecting the bosses 18 and 19 to each other. Thus, a large vibration reduction effect can be achieved for a whole motor housing 11a.

Features as described above in the present specification may be combined appropriately as long as no conflict arises.

In the above-described preferred embodiment, the housing 10 and the inverter case 41, which are separate cases, are joined together to form a unit. However, the housing 10 and the inverter case 41 may alternatively be defined by a single monolithic member. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor arranged to be capable of rotating about a central axis;
a stator located radially outside of the rotor;
a housing arranged to house the rotor and the stator; and
a plurality of bolts arranged to fasten the stator to the housing; wherein
the housing includes:
a tubular portion arranged radially outside of the stator to surround the stator;
a plurality of stator support portions each of which is arranged to project radially inward from an inner circumferential surface of the tubular portion, and includes a seating surface arranged to face a first axial side; and
screw holes each of which is arranged to open in the seating surface of a separate one of the stator support portions;
the stator includes a plurality of through holes each of which is arranged to extend along an axial direction;
the bolts are passed through the through holes of the stator and screwed into the screw holes of the stator support portions; and
the housing includes a rib arranged to project radially outward from an outer circumferential surface of the tubular portion on the first axial side of the seating surfaces of the stator support portions.

2. The motor according to claim 1, wherein the rib is located within an axial range on the outer circumferential surface of the tubular portion, the axial range extending from an end of the tubular portion on the first axial side toward the seating surfaces and having an axial extent equal to half of an axial distance between the end of the tubular portion on the first axial side and each seating surface.

3. The motor according to claim 1, wherein the rib is located within an axial range on the outer circumferential surface of the tubular portion, the axial range extending from an end of the tubular portion on the first axial side toward the seating surfaces and having an axial extent equal to one third of an axial distance between the end of the tubular portion on the first axial side and each seating surface.

4. The motor according to claim 1, wherein the rib is located between circumferentially adjacent ones of the bolts.

5. The motor according to claim 4, wherein the rib is located closer to a circumferential midpoint between the circumferentially adjacent bolts than to either of the circumferentially adjacent bolts in a circumferential direction.

6. The motor according to claim 1, wherein
the housing includes a flange located at an end portion thereof on the first axial side, and a boss located on the outer circumferential surface of the tubular portion; and
the rib is arranged to connect the flange and the boss to each other.

7. The motor according to claim 1, wherein
the housing includes a plurality of bosses located on the outer circumferential surface of the tubular portion; and
the rib is arranged to connect two of the bosses to each other.

8. The motor according to claim 1, wherein
the housing includes a boss located on the outer circumferential surface of the tubular portion, and a plurality of the ribs; and
the ribs include a first rib, and a second rib arranged to connect the first rib and the boss to each other.

9. A drive apparatus to be installed in a vehicle, the drive apparatus comprising:
the motor of claim 1; and
a transmission system connected to the motor.
